(19) United States
(12) Patent Application Publication
(10) Pub. No.: US 2016/0016116 A1
(43) Pub. Date: Jan. 21, 2016

(54) FORWARD OSMOSIS SYSTEM USING COORDINATION COMPLEXES

(71) Applicant: NATIONAL UNIVERSITY OF SINGAPORE, Singapore (SG)

(72) Inventors: Qingchun Ge, Singapore (SG); Tai-Shung Chung, Singapore (SG); Jincai Su, Singapore (SG); Yue Cui, Singapore (SG)

(73) Assignee: National University of Singapore, Singapore (SG)

(21) Appl. No.: 14/771,646

(22) PCT Filed: Apr. 7, 2014
(86) PCT No.: PCT/SG2014/000154

§ 371 Date: Aug. 31, 2015

Related U.S. Application Data
(60) Provisional application No. 61/853,462, filed on Apr. 5, 2013.

(51) Int. Cl. B01D 61/00; C07F 15/06; C07F 15/02; C02F 1/44; C07F 1/08

(52) U.S. Cl. CPC B01D 61/005; C02F 1/445; C07F 1/08; C07F 15/025; C07F 15/065; C02F 2103/08

(57) ABSTRACT

A forward osmosis system. The system contains a forward osmosis membrane, a draw solution, and a feed solution. The draw solution includes a coordination complex formed of a metal ion and an organic ligand coordinated to the metal ion. Also disclosed are a method of separating a liquid using such a forward osmosis system and a coordination complex used in this system.

### CROSS REFERENCE

This application claims the priority from U.S. Provisional Application 61/853,462, filed on Apr. 5, 2013. The contents of this application is incorporated by reference in its entirety.

### BACKGROUND

Forward osmosis utilizes a draw solution of a considerably high concentration to generate a hydrostatic osmotic pressure across a membrane to extract fresh water from a feed solution (such as seawater, brine, or any waste water) on the other side of the membrane.

Advantages of a forward osmosis method over others (e.g., reverse osmosis) include high feed water recovery, minimal brine discharge, and low cost in desalination and water reuse. One major challenge of this method lies in developing a safe and less expensive draw solution.

Conventionally, sugars and inorganic salts are used in draw solutions. However, these compounds have a high reverse draw solute flux or are expensive to recycle. Some of them are even toxic.

There is a need to develop a forward osmosis system that contains a non-toxic and inexpensive draw solution.

### SUMMARY

This invention is based on an unexpected discovery of a forward osmosis system that contains a safe, inexpensive, and efficient draw solution, i.e., a solution of a coordination complex.

One aspect of this invention relates to a forward osmosis system including a forward osmosis membrane, a feed solution, and a draw solution.

The forward osmosis membrane has a first side and a second side.

The feed solution is in contact with the forward osmosis membrane only on the second side. It contains a liquid to be separated (e.g., water). Examples include, but are not limited to, brackish water, seawater, wastewater, impaired water, a mixture of oil and water, a mixture of alcohol and water, an aqueous solution containing a pharmaceutical agent, an aqueous solution containing protein, and juice.

The draw solution, which can have an osmotic pressure of 5 atm or greater (e.g., 20 atm or greater), is in contact with the forward osmosis membrane only on the first side. It contains a coordination complex, which can have a concentration of 2.5 to 75 wt % (e.g., 20 to 55 wt %). The coordination complex is formed of a metal ion and an organic ligand that is coordinated to the metal ion. Examples of the metal ion include Ag⁺, Ti⁴⁺, Cr³⁺, Cr⁵⁺, Mn²⁺, Mn⁴⁺, Mn⁷⁺, Fe²⁺, Fe³⁺, Co²⁺, Co³⁺, Ni²⁺, Cu⁺, Cu²⁺, Zn²⁺, and a combination thereof. Examples of the organic ligand include organic compounds that each contain one or more carboxyl groups, such as citric acid, malic acid, tartaric acid, ethylenediaminetetraacetic acid, 1,3-diamino-2-hydroxypropane-N,N,N′,N′-tetraacetic acid, ethylene glycol-O,O′-bis (2-aminoethyl)-N,N,N′,N′,-tetraacetic acid, 1,2-bis(o-aminophenoxy)ethane-N,N,N′,N′-tetraacetic acid, 1,2-diaminocyclohexane-N,N,N′,N′-tetracetic acid monohydrate, N-(2-hydroxyethyl)ethylenediamine-N,N′,N′-triacetic acid, 1,4,7-triazacyclononane-N,N′,N″-triacetic acid, benzene-1,3,5-triacetic acid, and a combination thereof.

The forward osmosis system of this invention has a reverse draw solute flux of 0.15 g/m²·hr or lower (e.g., ≦0.1 g/m²·hr), a liquid permeation flux of 10 L/m²·hr or greater (e.g., ≧20 L/m²·hr), a ratio between the reverse draw solute flux and the liquid permeation flux being 0.01 g/L or lower (e.g., ≦0.005 g/L).

Another aspect of this invention relates to a method of separating a liquid (e.g., water), which includes the steps of: (i) providing the forward osmosis system described above, which contains a forward osmosis membrane having a first side and a second side, a draw solution, and a feed solution, (ii) placing the draw solution in contact with the forward osmosis membrane only on the first side, and (iii) placing the feed solution in contact with the forward osmosis membrane only on the second side, thereby obtaining a filtrate solution as the liquid in the feed solution passes through the forward osmosis membrane into the draw solution. Optionally, the liquid contained can be removed from the filtrate solution, which is formed of the liquid and the draw solution.

Also within the scope of this invention is the coordination complex described above for use in a draw solution of a forward osmosis system for separating a liquid (e.g., water).

The details of the invention are set forth in the description below. Other features, objects, and advantages of the invention will be apparent from the description and from the claims.

### DETAILED DESCRIPTION

This invention provides a forward osmosis system that has a high water flux and a low reverse solute rejection, useful for water reclamation and pharmaceutical agent/protein enrichment.

As pointed out above, the forward osmosis system of this invention includes a forward osmosis membrane, a feed solution containing a liquid to be separated (e.g., water, ethanol, and ethyl acetate), and a draw solution containing a coordination complex.

The forward osmosis membrane may be only permeable to the liquid to be separated but not to the coordination complex in the draw solution and any other components in the feed solution (e.g., a salt, a pharmaceutical agent, a particle, and a microorganism). Examples include cellulose acetate hollow fibers, double-skinned cellulose acetate flat-sheet membranes, polybenzimidazole (PBI) hollow fibers, and dual-layer polybenzimidazole-polyethersulfonr/polyvinylpyrrolidone hollow fibers. See Su et al., J. Membr. Sci. 2010, 355, 36-44; Wang et al., Ind. Eng. Chem. Res. 2010, 49, 4824-4831; and Yang et al., Environ. Sci. Technol. 2009, 43, 2800-2805.

The feed solution is typically an aqueous solution, including brackish water, seawater, urban wastewater, industrial wastewater, impaired water, a mixture of oil and water, a mixture of alcohol and water, juice, and a solution containing a pharmaceutical agent or a protein that is not a pharmaceutical agent. In these solutions, water is the liquid to be separated. The feed solution can also be an organic solution containing a chemical intermediate or a pharmaceutical agent dissolved in an organic solvent (e.g., methanol, ethanol, propanol, and ethyl acetate). The organic solvent is the liquid to be separated in these feed solutions.

Like the feed solution, the draw solution can be aqueous or organic. A coordination complex is dissolved in the draw solution (e.g., water-soluble) typically at a concentration of 2.5 to 75 wt %.

The coordination complex is formed of one or more metal ions coordinated with one or more organic ligands. Being stable and water soluble, the coordination complex exerts a high osmotic pressure in aqueous solution and has a low reverse draw solute flux when used in the draw solution of the forward osmosis system of this invention. More specifically, 1 mole/L coordination complex aqueous solution can have an osmotic pressure of 10 atm or higher (e.g., 20-80 atm, 25-70 atm, and 35-70 atm) and a reverse draw solute reflux of 1 gMH or lower (e.g., 0.5 gMH or lower, and 0.2 gMH or lower). Due to its large size, the coordination complex can be readily recovered from a draw solution (e.g., via ultrafiltration). One can design and prepare a coordination complex for use in a draw solution by choosing a suitable metal ion and organic ligand.

A suitable metal ion typically has a coordination number of two to nine (e.g., four to six). Examples include Fe²⁺, Fe³⁺, Co²⁺, Cu²⁺, Zn²⁺.

A suitable organic ligand can be a non-toxic polyacid having one or more carboxyl groups (e.g., two or more carboxyl groups). Examples include citric acid, malic acid, and tartaric acid. These polyacids have a good coordination capability with transition metals (e.g., copper, cobalt, and iron) and are highly hydrophilic.

A coordination complex can be prepared following procedures well-known in the field, e.g., Pignat et al., Organometallics 2000, 19, 5160-67; Ge et al., Dalton Trans. 2009, 6192-6200; and Powell et al., Organometallics 2007, 26, 4456-63.

The forward osmosis system of this invention can be used for desalination of brackish water or seawater, wastewater reclamation, and dehydration of biofuels.

Proteins can be denatured by salts or high temperature distillation and certain pharmaceutical agents are unstable at a high temperature. The system of this invention provides an alternative process for separating or enriching under a mild condition pharmaceutical agents and proteins that are not pharmaceutical agents.

The specific examples below are to be construed as merely illustrative, and not limitative of the remainder of the disclosure in any way whatsoever. Without further elaboration, it is believed that one skilled in the art can, based on the description herein, utilize the present invention to its fullest extent. All publications cited herein are incorporated by reference in their entirety.

### EXAMPLE 1

### Preparation of Coordination Complexes

Eight coordination complexes, i.e., Cu-CA, Fe-CA, Cu-MA, Fe-MA, Cu-TA, Fe-TA, Co-CA, and Co2-CA, were prepared for use in the forward osmosis system of this invention.

### Cupric Citric Acid Sodium Salt

Cupric citric acid sodium salt (i.e., Cu-CA), a coordination complex, suitable for use in the forward osmosis system of this invention, was prepared following the procedures described below.

Cu(NO₃)₂ (50 mmol, 11.6 g) and citric acid (52 mmol, 10.0 g) were dissolved in 50 mL water to obtain a clear blue solution. A 1 M NaOH aqueous solution was added dropwise to adjust the pH to 7. The color of the solution changed from its initial clear blue to dark blue. The resultant solution was stirred overnight at 50° C., and then concentrated by rotary evaporation to 10 mL. Cold ethanol was added to precipitate Cu-CA at a yield of 95%. The synthetic route is outlined in Scheme 1 below.

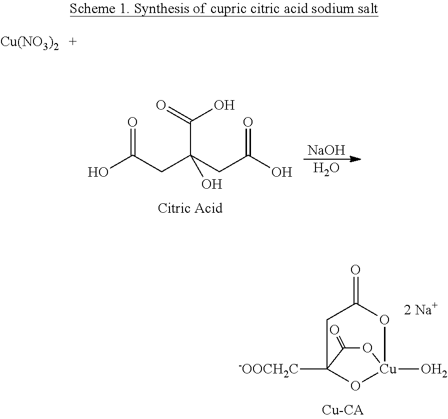

### Ferric Citric Acid Sodium Salt

Ferric citric acid sodium salt (Fe-CA, chemical structure shown below) was prepared following the same procedure described in Example 1 above except that Fe(NO₃)₃ was used instead of Cu(NO₃)₂.

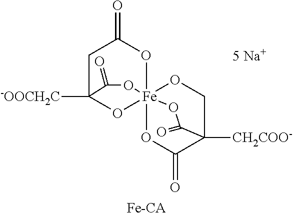

### Cupric Malic Acid Sodium Salt

Curpric malic acid sodium salt (Cu-MA) was prepared following the procedure described in Example 1 above except that malic acid was used instead of citric acid. The structures of Cu-MA and malic acid are shown below:

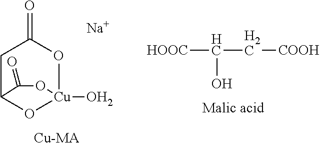

### Ferric Malic Acid Sodium Salt

Ferric malic acid sodium salt (Fe-MA; structure shown below) was prepared following the procedure described in Example 2 above except that malic acid was used instead of citric acid.

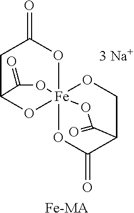

### Cupric Tartaric Acid Complex

Cupric tartaric acid sodium salt (Cu-TA) was prepared following the procedure described in Example 1 above except that tartaric acid was used instead of citric acid. The structures of Cu-TA and tartaric acid are shown below:

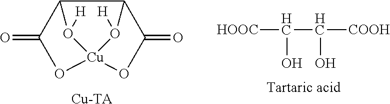

### Ferric Tartaric Acid Sodium Salt

Ferric tartaric acid sodium salt (Fe-TA; structure shown below) was prepared following the procedure described in Example 2 above except that tartaric acid was used instead of citric acid.

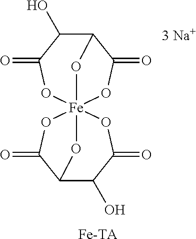

### Cobaltous Citric Acid Sodium Salt

Cobaltous citric acid sodium salt (Co-CA; structure shown below) was prepared following the procedure described in Example 1 above except that (i) Co(NO₃)₂ was used instead of Cu(NO₃)₂ and (ii) the molar ratio between Co(NO₃)₂ and citric acid is 1:2.

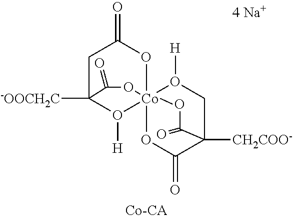

### Bicobaltous Citric Acid Sodium Salt

Bicobaltous citric acid sodium salt (Co2-CA; structure shown below) was prepared following the procedure described in Example 7 above except that the molar ratio between Co(NO₃)₂ and citric acid is 1:1.

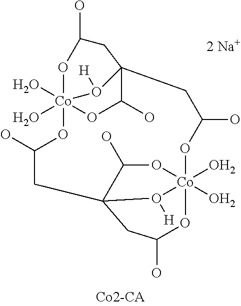

### Characterization of Coordination Complexes

Each of the eight coordination complexes thus prepared was characterized by Fourier transform infrared spectroscopy (FTIR) using a Perkin-Elmer FT-IR Spectrometer Spectrum 2000 to determine the functional groups of these complexes. The scan range was from 4000 to 400 cm⁻¹. Each sample containing a coordination complex was dried overnight under vacuum at 80° C. The spectra were obtained with a solid KBr method. The bonding between the organic ligand (e.g., citric acid, malic acid, and tartaric acid) and the metal was confirmed by FTIR spectroscopy (i.e., peaks at 3400, 1608-1720, and 1396-1472 cm⁻¹ corresponding to O—H, C═O, and C—O groups, respectively, indicating the presence of COOH; peaks at 570 cm⁻¹ corresponding metal-O bond).

### EXAMPLE 2

### Forward Osmosis Filtration Using Coordination Complexes

Each of the eight coordination complexes prepared in Example 1 was used in the forward osmosis system of this invention, following the assays and calculation described below, to determine the osmotic pressure, water flux, reverse draw solute flux, ratio of reverse draw solute flux (Jₛ) to water flux (Jᵥ) or Jₛ/Jᵥ, and salt rejection during recycling.

In these assays, the forward osmosis system of this invention was used, which contained (i) a draw solution having one of the eight coordination complexes, (ii) water as a feed solution, and (iii) a filtration membrane. Filtration was carried out in the filtration unit described in Wang et al., Ind. Eng. Chem. Res. 2010, 49 (10), 4824-31; and Su et al., J. Membr. Sci. 2010, 355, 36-44. Three forward osmosis membranes were used, i.e., cellulose acetate (CA) membrane; thin-film composite membranes fabricated on polyethersulfone supports (TFC-PES), and polybenzimidazole PES (PBI/PES) [19] hollow fiber membranes. See Su et al., J. Membr. Sci. 2010, 355, 36-44; Sukitpaneenit et al., Environ. Sci. & Technol. 2012, 46, 7358-65; and Fu et al., J. Membr. Sci. 2013, 443, 144-55, respectively. A draw solution was counter-currently pumped through the module and circulated on each side of membrane. A pressure retarded osmosis (PRO) mode was employed when the feed and draw solutions were against the support and selective layers, respectively. The pressures at the two channel inlets were below 0.07 bar (1.0 psi). A balance connected to a computer recorded the mass of water permeating into the draw solution during the experimental time.

The water permeation flux, Jᵥ, (L m⁻²hr⁻¹, abbreviated as LMH) is calculated from the volume change of the feed solution using equation (1).

Jᵥ=ΔV/(AΔt) (1)

where ΔV (L) is the volume change of the feed solution over a predetermined time Δt (hr) and A is the effective membrane surface area (m²).

To obtain the reverse flux of a coordination complex in a draw solution, the electrical conductivity of the solution was measured using a calibrated conductivity meter (Oakton Instruments, Vernon Hills, Ill.). The conductivity was then converted to the concentration of the coordination complex diffusing from the draw solution to the feed solution. The reverse flux or Jₛ (g·m⁻²·hr⁻¹, abbreviated as gMH) was determined from increase in the feed conductivity:

$${J}_{s} = \frac{( {C}_{t} {V}_{t} ) - ( {C}_{0} {V}_{0} )}{Δ t} \frac{1}{{A}_{m}} \qquad ( 2 )$$

where C₀ (mol·L⁻¹) and V₀ (L) are the initial salt concentration and the initial volume of the feed, respectively, while Cₜ (mol·L⁻¹) and Vₜ (L) are the salt concentration and the volume of the feed over a predetermined time Δt (h), respectively.

### Osmotic Pressure Measurement

Osmotic pressure is the pressure which needs to be applied to a solution to prevent the inward flow of water across a membrane. It can be determined using a model 3250 osmometer (Advanced Instruments, Inc.)

Osmotic pressure measurements were carried out on draw solutions each containing one of Cu-CA, Cu-MA, Cu-TA, Fe-CA, Fe-MA, Fe-TA, Co-CA, and Co2-CA. Four draw solutions of different concentrations, i.e., 0.5 mole/L, 1 mole/L, 1.5 mole/L, and 2 mole/L, were prepared.

The Cu-CA draw solutions showed an osmotic pressure of 19 atm at 0.5 mole/L, 37 atm at 1 mole/L, 49 atm at 1.5 mole/L, and 66 atm at 2 mole/L.

The Cu-MA draw solutions showed an osmotic pressure of 15 atm at 0.5 mole/L and 53 atm at 2 mole/L.

The Cu-TA draw solutions showed an osmotic pressure of 11 atm at 0.5 mole/L and 43 atm at 2 mole/L.

The Fe-CA draw solutions showed an osmotic pressure of 28 atm at 0.5 mole/L and 96 atm at 2 mole/L.

The Fe-MA draw solutions showed an osmotic pressure of 21 atm at 0.5 mole/L and 89 atm at 2 mole/L.

The Fe-TA draw solutions showed an osmotic pressure of 21 atm at 0.5 mole/L and 88 atm at 2 mole/L.

The Co-CA draw solutions showed an osmotic pressure of 20 atm at 0.5 mole/L and 81 atm at 2 mole/L.

The Co2-MA draw solutions showed an osmotic pressure of 18 atm at 0.5 mole/L and 68 atm at 2 mole/L.

### Forward Osmosis Performance on a Cellulose Acetate Hollow Fiber Membrane

Performances of the eight coordination complexes as draw solutes were evaluated in forward osmosis filtration through the cellulose hollow fiber membrane described in Su et al., J. Membr. Sci. 2010, 355, 36-44.

More specifically, draw solutions each at a pre-determined concentration were tested under the PRO mode described above. Four draw solutions of different concentrations, i.e., 0.5 mole/L, 1 mole/L, 1.5 mole/L, and 2 mole/L, were prepared.

The Cu-CA draw solutions showed a water flux of 13 LMH at 0.5 mole/L, 18 LMH at 1 mole/L, 25 LMH at 1.5 mole/L, and 30 LMH at 2 mole/L.

The Cu-MA draw solutions showed a water flux of 11 LMH at 0.5 mole/L and 26 LMH at 2 mole/L.

The Cu-TA draw solutions showed water flux of 8 LMH at 0.5 mole/L and 24 LMH at 2 mole/L.

The Fe-CA draw solutions showed a water flux of 15 LMH at 0.5 mole/L and 44 LMH at 2 mole/L.

The Fe-MA draw solutions showed a water flux of 14 LMH at 0.5 mole/L and 40 LMH at 2 mole/L.

The Fe-TA draw solutions showed a water flux of 14 LMH at 0.5 mole/L and 37 LMH at 2 mole/L.

The Co-CA draw solutions showed a water flux of 14 LMH at 0.5 mole/L and 35 LMH at 2 mole/L.

The Co2-MA draw solutions showed a water flux of 11 LMH at 0.5 mole/L and 30 LMH at 2 mole/L.

The reverse draw solute flux of each draw solution was also measured. Unexpectedly, the results showed that each coordination complex had an insignificant reverse draw solute flux below 0.15 gMH at the four concentrations investigated, i.e., 0.5 mole/L, 1 mole/L, 1.5 mole/L, and 2 mole/L.

The ratio of reverse draw solute flux (Jₛ) to water flux (Jᵥ), Jₛ/Jᵥ, is useful to estimate the amount of the coordination complex lost during the forward osmosis process to recover one liter of water. Jₛ/Jᵥ also shows the amount of the coordination complex needed to be replenished to maintain the draw solution at a certain concentration. Further, Jₛ/J_{w} is useful in selecting a suitable forward osmosis membrane and draw solute. The results show that the Jₛ/Jᵥ value for each coordination complex draw solution was negligible, i.e., <0.003 g·L⁻¹, indicating that, for each liter of water recovered through a forward osmosis process, less than 0.003 g of a coordination complex diffused to the feed side through the membrane.

NaCl, an effective draw solute in a forward osmosis system, was used as a comparison to the eight coordination complexes. At the concentration of 3.5% in water, NaCl showed a water flux of 11.9 LMH and a reverse draw solute flux of 36.5 gMH.

### Forward Osmosis Performance on a TFC-PES Hollow Fiber Membrane

The performance of Fe-CA and Co-CA as draw solutes was evaluated in forward osmosis filtration through the TFC-PES hollow fiber membrane described in Sukitpaneenit et al., Environ. Sci. & Technol. 2012, 46, 7358-65.

More specifically, draw solutions each at a pre-determined concentration were tested under the PRO mode described above. Four draw solutions of different concentrations, i.e., 0.5 mole/L, 1 mole/L, 1.5 mole/L, and 2 mole/L, were prepared.

The Fe-CA draw solutions showed a water flux of 17 LMH at 0.5 mole/L, 28 LMH at 1 mole/L, 39 LMH at 1.5 mole/L, and 47 LMH at 2 mole/L.

The Co-CA draw solutions showed a water flux of 34 LMH at 1.5 mole/L, and 41 LMH at 2 mole/L.

As a comparison, the draw solutions containing NaCl showed a water flux of 15 LMH at 0.5 mole/L, 24 LMH at 1 mole/L, 32 LMH at 1.5 mole/L, and 39 LMH at 2 mole/L.

Both Fe-CA and Co-CA showed very low reverse draw solute refluxes, i.e., below 0.15 gMH. By contrast, NaCl showed a reverse draw solute reflux of 0.8 gMH at 0.5 mole/L, 1.3 gMH at 1 mole/L, 1.8 gMH at 1.5 mole/L, and 2.1 gMH at 2 mole/L.

### Forward Osmosis Performance on a PBI/PES Hollow Fiber Membrane

The performances of Fe-CA, Co-CA, and Co2-CA as draw solutes were evaluated in forward osmosis filtration through the PBI/PES hollow fiber membrane described in Fu et al., J. Membr. Sci. 2013, 443, 144-55.

More specifically, draw solutions each at a pre-determined concentration were tested under PRO mode described above. Four draw solutions of different concentrations, i.e., 0.5 mole/L, 1 mole/L, 1.5 mole/L, and 2 mole/L, were prepared.

The Fe-CA draw solutions showed a water flux of 13 LMH at 0.5 mole/L, 21 LMH at 1 mole/L, 28 LMH at 1.5 mole/L, and 33 LMH at 2 mole/L.

The Co-CA draw solutions showed a water flux of 12 LMH at 0.5 mole/L, 19 LMH at 1 mole/L, 25 LMH at 1.5 mole/L, and 29 LMH at 2 mole/L.

The Co2-CA draw solutions showed a water flux of 9 LMH at 0.5 mole/L, 14 LMH at 1 mole/L, 21 LMH at 1.5 mole/L, and 24 LMH at 2 mole/L.

Each of Fe-CA, Co-CA, and Co2-CA showed a very low reverse draw solute reflux, i.e., below 0.12 gMH.

### Desalination of Brackish Water and Seawater

In view of the above performance results, Fe-CA solution at 2.0 mole/L was used as the draw solution in the forward osmosis system of this invention to desalinate a model seawater containing 35 g/L NaCl using the cellulose acetate or TFE-PES hollow fiber membrane discussed above. Water fluxes of 17.4 and 13.1 LMH were achieved for TEF-PES and cellulose acetate membranes, respectively. As reported in Su et al., J. Membr. Sci. 2011, 376, 214-224, draw solution 2.0 mole/L MgCl₂ has a water reflux of 9.98 LMH for the cellulose acetate membrane.

Recycling of Coordination Complexes from Filtrate Solutions

In a forward osmosis filtration, water was drawn from a feed solution into a draw solution to obtain a diluted draw solution, i.e., a filtrate solution, which was re-concentrated through a pressure-driven process, ultrafiltration. The salt rejection in the ultrafiltration is calculated by equation (3):

$$R = ( 1 - \frac{{C}_{P}}{{C}_{F}} ) \times 100 \% \qquad ( 3 )$$

where R is the salt rejection, C_{P} (mol·L⁻¹) is the solute concentration in the permeate, and C_{F} (mol·L⁻¹) is the solute concentration in the feed solution.

A thin-film polyamide NF membrane (NE2540-70) was used for the Fe-CA regeneration under a gas pressure of 10-bar. A high rejection rate of more than 90% was achieved when the concentration of the filtrate solution was between 0.05 and 0.10 M.

Separation of Heavy Metal Ions from Wastewater

Co-CA solution was used as the draw solution in the forward osmosis system of this invention to separate heavy metal ions using a thin film composite membrane, which contains a polyamide reject layer via interfacial polymerization upon on macrovoid-free polyimide support (i.e., a Matrimid substrate). The feed solution was selected from six heavy metal solutions, i.e., Na₂Cr₂O₇, Na₂HAsO₄, Pb(NO₃)₂, CdCl₂, CuSO₄, Hg(NO₃)₂, at 2000 ppm or 5000 ppm. Water fluxes around 11 LMH were harvested with heavy metals rejections of more than 99.5% when employing 1M Na—Co-CA as the draw solution to process 2000 ppm heavy metal solutions. In addition, the high rejections were maintained at 99.5% when a 1.5 M draw solution and a 5000 ppm feed solution were utilized.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A forward osmosis system, comprising:
a forward osmosis membrane having a first side and a second side,
a draw solution in contact with the forward osmosis membrane only on the first side and containing a coordination complex, and
a feed solution in contact with the forward osmosis membrane only on the second side and containing a liquid,
wherein the coordination complex contains a metal ion and an organic ligand that is coordinated to the metal ion.

2. The forward osmosis system of claim 1, wherein the metal ion is Ag⁺, Ti⁴⁺, Cr³⁺, Cr⁵⁺, Mn²⁺, Mn⁴⁺, Mn⁷⁺, Fe²⁺, Fe³⁺, Co²⁺, Co³⁺, Ni²⁺, Cu⁺, Cu²⁺, Zn²⁺, or a combination thereof, and the organic ligand is an organic compound that contains one or more carboxyl groups.

3. The forward osmosis system of claim 1, wherein the system has a reverse draw solute flux of 0.15 g/m²hr or lower and a liquid permeation flux of 10 L/m²·hr or greater, a ratio between the reverse draw solute flux and the liquid permeation flux being 0.01 g/L or lower; and the draw solution contains the coordination complex 2.5 to 75 wt % and has a osmotic pressure of 5 atm or greater.

4. The forward osmosis system of claim 1, wherein the system has a reverse draw solute flux of 0.1 g/m²·hr or lower and a liquid permeation flux of 20 L/m²·hr or greater, a ratio between the reverse draw solute flux and the liquid permeation flux being 0.005 g/L or lower; and the draw solution contains the coordination complex 20 to 55 wt % and has a osmotic pressure of 20 atm or greater.

5. The forward osmosis system of claim 1, wherein the feed solution, containing water to be purified, is brackish water, seawater, wastewater, impaired water, a mixture of oil and water, a mixture of alcohol and water, an aqueous solution containing a pharmaceutical agent, an aqueous solution containing protein, or juice.

6. The forward osmosis system of claim 1, wherein the metal ion is Fe²⁺, Fe³⁺, Co²⁺, Cu²⁺, Zn²⁺, or a combination thereof; and the organic ligand is citric acid, malic acid, tartaric acid, ethylenediaminetetraacetic acid, 1,3-diamino-2-hydroxypropane-N,N,N′,N′-tetraacetic acid, ethylene glycol-O,O′-bis (2-aminoethyl)-N,N,N′,N′,-tetraacetic acid, 1,2-bis(o-aminophenoxy)ethane-N,N,N′,N′-tetraacetic acid, 1,2-diaminocyclohexane-N,N,N′,N′-tetracetic acid monohydrate, N-(2-hydroxyethyl) ethylenediamine-N,N′,N′-triacetic acid, 1,4,7-triazacyclononane-N,N,N″-triacetic acid, benzene-1,3,5-triacetic acid, or a combination thereof.

7. The forward osmosis system of claim 1, wherein the system has a reverse draw solute flux of 0.15 g/m²·hr or lower and a liquid permeation flux of 10 L/m²·hr or greater, a ratio between the reverse draw solute flux and the liquid permeation flux being 0.01 g/L or lower; and the draw solution contains the coordination complex 2.5 to 75 wt % and has a osmotic pressure of 5 atm or greater.

8. The forward osmosis system of claim 1, wherein the system has a reverse draw solute flux of 0.1 g/m²·hr or lower and a liquid permeation flux of 20 L/m²·hr or greater, a ratio between the reverse draw solute flux and the liquid permeation flux being 0.005 g/L or lower; and the draw solution contains the coordination complex 20 to 55 wt % and has a osmotic pressure of 20 atm or greater.

9. The forward osmosis system of claim 1, wherein the feed solution, containing water to be purified, is brackish water, seawater, wastewater, impaired water, a mixture of oil and water, a mixture of alcohol and water, an aqueous solution containing a pharmaceutical agent, an aqueous solution containing protein, or juice.

10. The forward osmosis system of claim 1, wherein the system has a reverse draw solute flux of 0.15 g/m²·hr or lower and a liquid permeation flux of 10 L/m²·hr or greater, a ratio between the reverse draw solute flux and the liquid permeation flux being 0.01 g/L or lower; and the draw solution contains the coordination complex 2.5 to 75 wt % and has a osmotic pressure of 5 atm or greater.

11. The forward osmosis system of claim 1, wherein the system has a reverse draw solute flux of 0.1 g/m²·hr or lower and a liquid permeation flux of 20 L/m²·hr or greater, a ratio between the reverse draw solute flux and the liquid permeation flux being 0.005 g/L or lower; and the draw solution contains the coordination complex 20 to 55 wt % and has a osmotic pressure of 20 atm or greater.

12. The forward osmosis system of claim 1, wherein the feed solution, containing water to be purified, is brackish water, seawater, wastewater, impaired water, a mixture of oil and water, a mixture of alcohol and water, an aqueous solution containing a pharmaceutical agent, an aqueous solution containing protein, or juice.

13. A method of separating a liquid, the method comprising:
providing a forward osmosis system including a forward osmosis membrane, a draw solution, and a feed solution, the forward osmosis membrane having a first side and a second side,
placing the draw solution in contact with the forward osmosis membrane only on the first side, the draw solution containing a coordination complex formed of a metal ion and an orgainc ligand that is coordinated to the metal ion, and
placing the feed solution in contact with the forward osmosis membrane only on the second side, the feed solution containing a liquid to be separated, thereby obtaining a filtrate solution as the liquid in the feed solution passes through the forward osmosis membrane into the draw solution, the filtrate solution formed of the liquid and the draw solution.

14. The method of claim 13, wherein the system has a reverse draw solute flux of 0.15 g/m²·hr or lower and a liquid permeation flux of 10 L/m²·hr or greater, a ratio between the reverse draw solute flux and the liquid permeation flux being 0.01 g/L or lower; the draw solution contains the coordination complex 2.5 to 75 wt %, and has a osmotic pressure of 5 atm or greater; the metal ion is Ag⁺, Ti⁴⁺, Cr³⁺, Cr⁵⁺, Mn²⁺, Mn⁴⁺, Mn⁷⁺, Fe²⁺, Fe³⁺, Co²⁺, Co³⁺, Ni²⁺, Cu⁺, Cu²⁺, Zn²⁺, or a combination thereof;
and the organic ligand is an organic compound that contains one or more carboxyl groups.

15. The method of claim 14, wherein the system has a reverse draw solute flux of 0.1 g/m²·hr or lower and a liquid permeation flux of 20 L/m²·hr or greater, a ratio between the reverse draw solute flux and the liquid permeation flux being 0.005 g/L or lower; the draw solution contains the coordination complex 20 to 55 wt % and has a osmotic pressure of 20 atm or greater; the metal ion is Fe²⁺, Fe³⁺, Co²⁺, Cu²⁺, Zn²⁺, or a combination thereof; and the organic ligand is citric acid, malic acid, tartaric acid, ethylenediaminetetraacetic acid, 1,3-diamino-2-hydroxypropane-N,N,N′,N′-tetraacetic acid, ethylene glycol-O,O′-bis (2-aminoethyl)-N,N,N′,N′,tetraacetic acid, 1,2-bis(o-aminophenoxy)ethane-N,N,N′,N′-tetraacetic acid, 1,2-diaminocyclohexane-N,N,N′,N′-tetracetic acid monohydrate, N-(2-hydroxyethyl) ethylenediamine-N,N′,N′-triacetic acid, 1,4,7-triazacyclononane-N,N′,N″-triacetic acid, benzene-1,3,5-triacetic acid, or a combination thereof.

16. The method of claim 15, furthering comprising removing the liquid from the filtrate solution, the liquid being water.

17. A coordination complex for use in a draw solution of a forward osmosis system for separating a liquid, wherein the coordination complex contains a metal ion and an organic ligand that is coordinated to the metal ion.

18. The coordination complex of claim 17, wherein the metal ion is Ag⁺, Ti⁴⁺, Cr³⁺, Cr⁵⁺, Mn²⁺, Mn⁴⁺, Mn⁷⁺, Fe²⁺, Fe³⁺, Co²⁺, Co³⁺, Ni²⁺, Cu⁺, Cu²⁺, Zn²⁺, or a combination thereof; and the organic ligand is citric acid, malic acid, tartaric acid, ethylenediaminetetraacetic acid, 1,3-diamino-2-hydroxypropane-N,N,N′,N′-tetraacetic acid, ethylene glycol-O,O′-bis (2-aminoethyl)-N,N,N′,N′,-tetraacetic acid, 1,2-bis(o-aminophenoxy)ethane-N,N,N′,N′-tetraacetic acid, 1,2-diaminocyclohexane-N,N,N′,N′-tetracetic acid monohydrate, N-(2-hydroxyethyl)ethylenediamine-N,N′,N′-triacetic acid, 1,4,7-triazacyclononane-N,N′,N″-triacetic acid, benzene-1,3,5-triacetic acid, or a combination thereof.

19. The coordination complex of claim 18, wherein the metal ion is Fe²⁺, Fe³⁺, Co²⁺, Cu²⁺, Zn²⁺, or a combination thereof; and the organic ligand is citric acid, malic acid, tartaric acid, or a combination thereof.

20. The coordination complex of claim 17, wherein the organic ligand is an organic compound that contains one or more carboxyl groups.
